(19) United States
(12) Patent Application Publication
(10) Pub. No.: US 2025/0316892 A1
(43) Pub. Date: Oct. 9, 2025

(54) Biometric Sensor Assembly with Integrated Antenna

(71) Applicant: Google LLC, Mountain View, CA (US)

(72) Inventors: Pei Li, Milpitas, CA (US); Zheyu Wang, Saratoga, CA (US)

(21) Appl. No.: 18/865,615

(22) PCT Filed: Jun. 16, 2022
(86) PCT No.: PCT/US2022/033742

§ 371 Date: Nov. 13, 2024

(51) Int. Cl. H01Q 1/27; G04G 17/06; G04G 21/02; H01Q 5/392

(52) U.S. Cl. CPC H01Q 1/273; G04G 17/06; G04G 21/025; H01Q 5/392

(57) ABSTRACT

A sensor assembly is provided. The sensor assembly includes a printed circuit board and one or more biometric sensor circuits coupled to the printed circuit board. The sensor assembly includes a cover having one or more electrodes disposed on an outer side of the cover coupled to one or more electrical traces disposed on an inner side of the cover. The one or more electrical traces are electrically coupled to the one or more biometric sensor circuits. The sensor assembly also includes an antenna electrically coupled to the one or more electrodes. Wearable computing devices incorporating the sensor assembly are also provided.

### FIELD

The present disclosure relates generally to sensor assemblies, such as sensor assemblies for wearable computing devices. More particularly, the present disclosure relates to a sensor assembly that includes an antenna electrically coupled to a sensor electrode(s) to improve performance (e.g., radiation efficiency) of the antenna.

### BACKGROUND

Recent advances in technology, including those available through consumer devices, have provided for corresponding advances in health detection and monitoring. For example, devices such as fitness bands and smartwatches are able to determine information relating to the health of a person wearing the device. It is desirable to be able to provide as much functionality as possible, but the limited form factor of these devices makes it challenging to include the necessary components.

Given the multi-functionality of electronic devices, a need exists for a sensor assembly for a wearable computing device that can improve the operation of other components of the device, such as the antenna.

### SUMMARY

Aspects and advantages of embodiments of the present disclosure will be set forth in part in the following description, or can be learned from the description, or can be learned through practice of the embodiments.

In one aspect, a sensor assembly is provided. The sensor assembly includes a printed circuit board, one or more biometric sensor circuits disposed on the printed circuit board, a cover having one or more electrodes disposed on the outer surface coupled to one or more electrical traces disposed on an inner surface of the cover, and an antenna electrically coupled to the one or more electrodes.

In some implementations, the antenna can be radio-frequency coupled to the one or more electrodes.

In some implementations, the electrodes can be electrically coupled to the printed circuit board by one or more conductive foam pads, one or more spring clips, one or more pogo-pins, or combinations thereof.

In some implementations, the conductive foam pads can be a foam material having one or more layers of conductive fabric thereon.

In some implementations, the electrodes can be stainless steel, aluminum, or a chromium and silver composite material.

In some implementations, the antenna can be copper.

In some implementations, the biometric sensor circuits can include an electrocardiogram (ECG) circuit.

In some implementations, the biometric sensor circuits can include a photoplethysmography (PPG) circuit.

In some implementations, the printed circuit board can be a flexible circuit board.

In another aspect, a wearable computing device including an electrode and antenna is provided. The wearable computing device can include a main circuit board, a flexible printed circuit board electrically coupled to the main circuit board, biometric sensor circuits coupled to the flexible printed circuit board, a cover having one or more electrodes disposed on an outer side of the cover coupled to one or more electrical traces disposed on an inner side of the cover, the one or more electrical traces electrically coupled to the one or more biometric sensor circuits, and an antenna electrically coupled to the one or more electrodes and the main circuit board.

In some implementations, the antenna can be radio-frequency coupled to the one or more electrodes.

In some implementations, the electrical traces can be electrically coupled to the biometric sensor circuits by one or more conductive foam pads, one or more spring clips, one or more pogo-pins, or combinations thereof.

In some implementations, the conductive foam pads can be a foam material having one or more layers of conductive fabric thereon.

In some implementations, the electrodes can be stainless steel, aluminum, or a chromium and silver composite material.

In some implementations, the antenna can be copper.

In some implementations, the biometric sensor circuits can be an ECG circuit.

In some implementations, the biometric sensor circuits can be a PPG.

In some implementations, a first antenna spring clip can be electrically coupled to the antenna and an antenna tuning circuit disposed on the main circuit board. The first antenna tuning circuit can be electrically coupled to a cellular modem disposed on the main circuit board.

In some implementations, a second antenna spring clip can be electrically coupled to the antenna and a second antenna tuning circuit disposed on the main circuit board. The second antenna tuning circuit can be electrically coupled to an RF circuit disposed on the main circuit board or can be electrically coupled to ground.

In some implementations, the device can include a wireless charging pairing device configured to operate at an operational frequency to wirelessly charge the device.

In some implementations, the device includes a capacitor electronically coupled to the antenna, the antenna configured to filter signals at the operational frequency of the wireless charging pairing device.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts an exploded view of a sensor assembly according to some implementations of the present disclosure.

FIG. 2 depicts an exploded view of a sensor assembly according to some implementations of the present disclosure.

FIG. 3 depicts a perspective view of the electrodes according to some implementations of the present disclosure.

FIG. 4 depicts a perspective view of the electrodes according to some implementations of the present disclosure.

FIG. 5 is a graph illustrating radiation efficiency of the antenna according to some implementations of the present disclosure.

FIG. 6 depicts a perspective view of a wearable computing device according to some implementations of the present disclosure.

FIG. 7 depicts a perspective view of the electrodes on a wearable computing device according to some implementations of the present disclosure.

FIG. 8 depicts an exploded view of the sensor assembly on a wearable computing device according to some implementations of the present disclosure.

FIG. 9 depicts a cross sectional view of a wearable computing device including the sensor assembly according to some implementations of the present disclosure.

FIG. 10 depicts a partial exploded perspective view of components of a wearable computing device according to some implementations of the present disclosure.

FIG. 11 depicts a schematic of an antenna circuit according to some implementations of the present disclosure.

FIG. 12 depicts a schematic of an antenna circuit according to some implementations of the present disclosure.

FIG. 13 depicts a schematic of an antenna circuit according to some implementations of the present disclosure.

### DETAILED DESCRIPTION

Reference now will be made in detail to embodiments of the disclosure, one or more examples of which are illustrated in the drawings. Each example is provided by way of explanation of the disclosure, not limitation of the disclosure. In fact, it will be apparent to those skilled in the art that various modifications and variations can be made in the present disclosure without departing from the scope or spirit of the disclosure. For instance, features illustrated or described as part of one embodiment can be used with another embodiment to yield a still further embodiment. Thus, it is intended that the present disclosure covers such modifications and variations as come within the scope of the appended claims and their equivalents.

As used herein, the terms “about,” “approximately,” or “generally,” when used to modify a value, indicates that the value can be raised or lowered by 5% and remain within the disclosed embodiment. Further, when a plurality of ranges are provided, any combination of a minimum value and a maximum value described in the plurality of ranges are contemplated by the present disclosure. For example, if ranges of “from about 20% to about 80%” and “from about 30% to about 70%” are described, a range of “from about 20% to about 70%” or a range of “from about 30% to about 80%” are also contemplated by the present disclosure.

Example aspects of the present disclosure are directed to a sensor assembly that can be included in a wearable computing device that can be worn, for instance, on a user's wrist or other location on the user's body. The sensor assembly includes biometric sensor circuitry coupled to a printed circuit board, two electrodes disposed on a cover, and an antenna. Although any type of antenna is contemplated by the present disclosure, it should also be understood that the antenna can operate at other frequency bands, such as those utilized in LTE, Wi-Fi, and Bluetooth applications as would be known to those of ordinary skill in the art.

Regardless of the particular application for which the sensor assembly is to be utilized, the sensor assembly includes one or more electrodes configured to electronically couple with the antenna to improve the operating efficiency of the antenna. Advantageously material selection of the electrodes facilitates operational functionality at lower frequency requirements necessary to collect signals for processing by the biometric sensor circuitry, and facilitates electrical coupling (e.g., radio frequency coupling) to the antenna at higher frequencies, thus improving the operational efficiency of the antenna. Specifically, the electrodes are formed from a metal material, such as a silver and chromium composite material, which allows for proper functioning with the biometric signal circuitry and also facilitates radio frequency (RF) coupling to the antenna. Further, the metal material selected can be aesthetically pleasing for the end user, which is important as the electrodes can be disposed on the outer surface of a cover for a computing device, such as a wearable computing device (e.g., a smartwatch). Since the electrodes are viewable by the user, material selection for the electrodes must maintain desired functionality while also being aesthetically pleasing.

Proximity of the electrodes to the antenna can also facilitate electrical coupling between the antenna and the electrodes. For instance, the distance between the antenna and the electrodes can be precisely controlled to be within certain ranges to ensure electrical coupling between the electrodes and the antenna. Additionally, in certain applications, such as wearable computing devices, space for including operational elements of the device is limited. Accordingly, it can be difficult to include additional component materials or other antennas in the wearable computing device in order to improve operation of the antenna. Thus, inclusion of electrodes having dual functionality can improve performance of the antenna without having to include additional components in an already limited space. The electrodes can improve the radiation efficiency of the antenna at one or more LTE frequency bands ranging from about 600 MHz to about 960 MHz. For example, the radiation efficiency of the antenna can be improved at one or more LTE frequency bands by at least about 2 decibels, such as at least about 3 decibels, such as at least about 4 decibels, such as at least about 5 decibels.

The electrodes can be disposed on an outer side of a cover that is configured to come into contact with the user's skin. The electrodes are coupled to electrical traces disposed on an inner surface of the cover, which are electrically coupled to the printed circuit board. The electrical traces can be electrically coupled to the printed circuit board via conductive foam pads, such as a foam material that is wrapped in one or more layers of conductive fabric. The conductive foam pad is disposed between the electrical traces and the printed circuit board. The properties of the foam material (e.g., density, inflation force deflection (IFD)) can be carefully selected such that the foam material does not act to increase force within the assembly. The foam material can be layered with conductive fabric to facilitate electrical connection between the electrodes (via the electrical traces) and the printed circuit board. The conductive fabric can include any woven or non-woven fabric including conductive elements dispersed therein. For instance, the conductive fabric can be made from thermoplastic polymers (e.g., polyesters) that are plated or embedded with metal materials, such as copper or nickel. The conductive fabric can have a resistance of less than 1 ohm per foot in any direction across the textile.

Sensor circuitry is disposed on the printed circuit board. For instance, the sensor circuitry can include biometric sensor circuitry. Biometric sensor circuitry can be disposed on the printed circuit board. The biometric sensor circuit can include electrocardiogram (ECG) circuitry or photoplethysmography (PPG) circuitry. Additional biometric sensor circuitry can be included on the printed circuit board as desired. For instance, the biometric sensor circuit can include electrodermal activity monitoring (EDA) circuitry and/or bioelectrical impedance analysis (BIA) circuitry. The sensor assembly can be incorporated into numerous devices where biometric sensor capabilities are desired.

Further, in embodiments pertaining to a wearable computing device, the antenna can be electrically connected to a main printed circuit board. For instance, a first fastener (e.g., a spring clip, booster pin, compression spring, etc.) can be used to electrically couple the antenna to a first antenna tuning circuit disposed on the main circuit board. The first antenna tuning circuit can electrically couple the antenna to a power radiator, a RF circuit, or a cellular modem. Additionally, the antenna can be direct current (DC) grounded to the main printed circuit board at a second location thereon. For instance, a second fastener (e.g., spring clip, booster pin, compression spring, etc.) can be used to electrically couple the antenna to a second antenna tuning circuit that is electrically coupled to ground. Additional fasteners can be utilized to electrically couple the antenna to other antenna circuits on the main printed circuit board as desired. The first location and the second location can be spaced apart from one another along the printed circuit board. Furthermore, the printed circuit board can include a first fastener (e.g., spring clip, booster pin, compression spring, etc.) at the first location and a second fastener (e.g., spring clip, booster pin, compression spring, etc.) at the second location to couple the antenna to the main printed circuit board via a first opening and a second opening at the first location and the second location, respectively. For example, a first contact of the antenna and/or a second contact of the antenna can be mechanically coupled and/or electrically coupled to the main printed circuit board via the first fastener and the second fastener, respectively, rather than via a solder connection. It should be understood that the antenna tuning circuit(s) can include various electronic components (e.g., capacitors, inductors, resistors, switching devices, etc.) to facilitate electrically coupling the antenna to a radiator, cellular modem, or for grounding the antenna. For instance, the antenna can be RF grounded or DC grounded to the main printed circuit board.

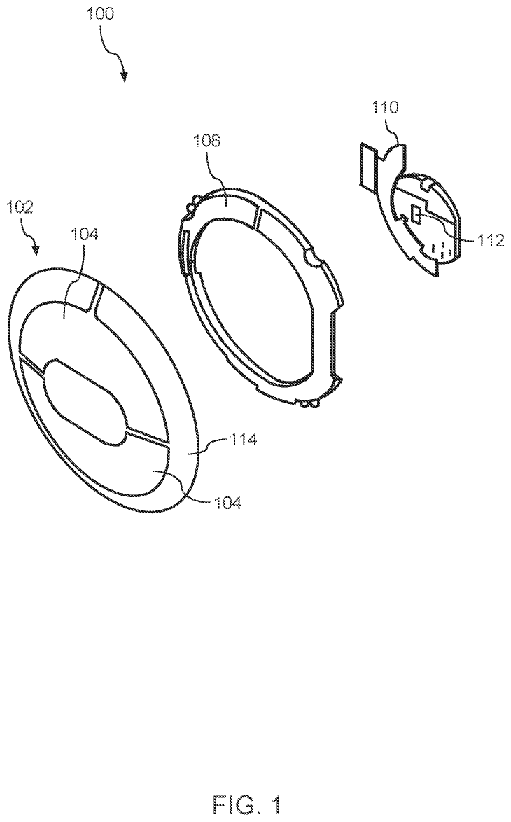

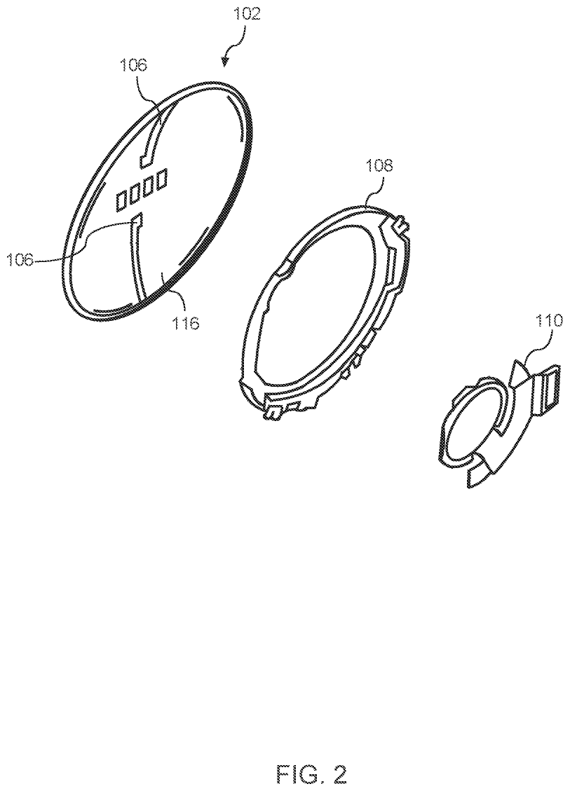

Referring now to the FIGS., FIGS. 1-2 depict a sensor assembly 100 according to some implementations of the present disclosure. The sensor assembly includes a cover 102 having electrodes 104 and electrical traces 106 disposed thereon. The sensor assembly 100 further includes an antenna 108 and a printed circuit board 110. Biometric sensor circuitry 112 is disposed on the printed circuit board. In certain embodiments, the printed circuit board 110 is a flexible printed circuit board. Biometric sensor circuitry 112 can be placed anywhere on the printed circuit board 110 as space allows. Biometric sensor circuitry 112 can include ECG circuitry and/or PPG circuitry. In such embodiments, the ECG circuitry and PPG circuitry can be placed at an optimal location for the particular device design. ECG and. PPG circuitry can include any appropriate circuitry known, used, or appropriate for such functionality. The electrode 104 can be connected to an ECG circuit that can detect small changes in electrical charge on the skin that vary with the user's heartbeat. ECG data can be monitored over time to attempt to determine irregularities in heartbeat that might indicate serious cardiac issues. Conventional ECG measurements are obtained by measuring the electrical potential of the heart over a period of time, typically corresponding to multiple cardiac cycles. By a user placing his or her skin (e.g., wrist or fingers) on the exposed electrode for a minimum period of time, during which ECG measurements are taken, an application executing on the sensor assembly can collect and analyze the ECG data and provide feedback to the user.

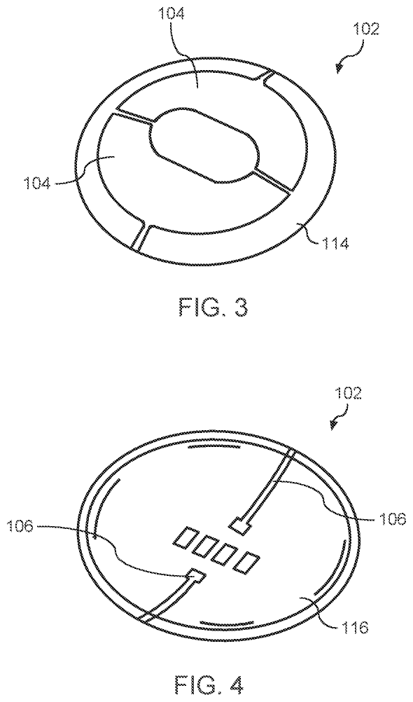

As shown more specifically in FIGS. 3-4, the cover 102 includes an outer surface 114 on which the electrodes 104 are disposed. In this example, the electrodes 104 are at least a portion of a metallic ring although other types and forms of electrodes can be used as well within the scope of the various embodiments. The electrode 104 is configured to be placed on the skin of a user and can detect small changes in electrical charge on the skin that vary with the user's heartbeat. While two electrodes are illustrated, the disclosure is not so limited, indeed it is contemplated that only one electrode could be utilized, or additional electrodes can be utilized as space allows. As shown more particularly in FIG. 4, the electrodes 104 on the outer surface 114 of the cover 102 are coupled to electrical traces 106 disposed on the inner surface 116 of the cover 102. The electrical traces 106 are then coupled to the printed circuit board 110 as will be further discussed hereinbelow.

The electrodes 104 are formed from metallic material and are of sufficiently large size, at least relative to the size of the cover 102 or to the computing device on which the sensor assembly 100 is integrated, in order to allow for good contact with the skin of the user. In one example embodiment, the electrodes 104 have the size on the order of at least 150 mm². The electrodes 104 are formed from a metal material, such as stainless steel, aluminum, or a silver and chromium composite material. Selection of the metal material allows for the electrodes 104 to be functional at low frequency DC requirements to collect signals for biometric sensor circuitry 112 on the printed circuit board 110. Further, the electrodes 104 are capable of RF coupling with the antenna 108 in order to improve the radiation efficiency of the antenna 108. Specifically, the material and size of the electrodes 104 as well as their location with respect to the antenna 108 contribute to the electrodes 104 ability to resonate electrically at operational frequencies of the antenna 108, thus boosting radiation performance of the antenna 108.

The antenna 108 can have a signal that operates at a plurality of different frequency bands. For example, the antenna 108 can operate at one or more global navigation satellite systems (GNSS) (e.g., global positioning system (GPS), GLONASS, Galileo, etc.) frequency bands. For instance, the one or more global navigation satellite system frequency bands can include one or more GPS frequency bands (e.g., 1164 MHz to 1189 MHZ, 1563 MHz to 1587 MHz, 1215 MHz to 1240 MHZ). It should also be understood that the antenna 108 can operate at other frequency bands, such as those utilized in LTE, Wi-Fi, and Bluetooth applications as would be known to those of ordinary skill in the art. The antenna 108 is formed from any suitable metallic material. In certain embodiments, the antenna 108 is formed from copper, a copper alloy, or any other material including copper.

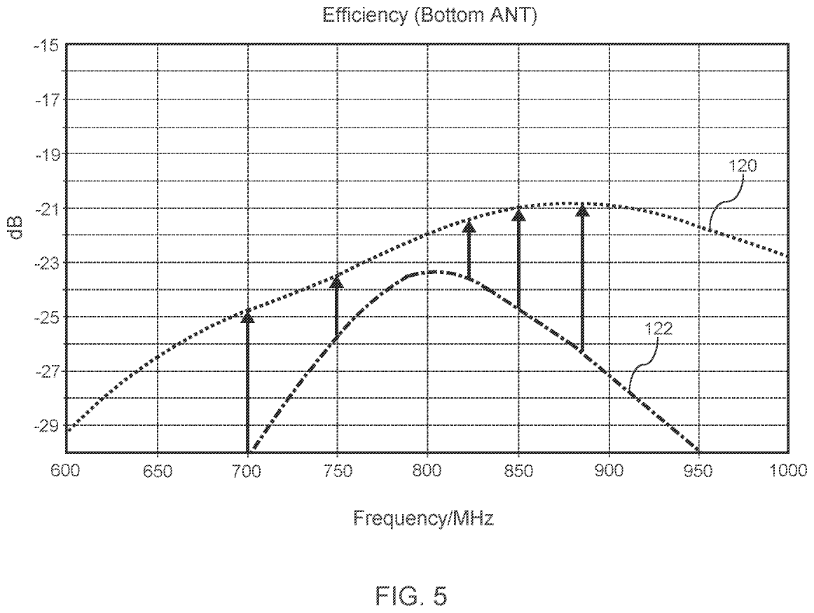

The electrodes 104 emit radiation that induces one or more electrical currents on the antenna when operating at the one or more frequency bands, which can improve performance (e.g., radiation efficiency) of the antenna 108 at the one or more frequency bands. For example, the electrodes 104 can improve radiation efficiency in frequency bands such as those utilized in LTE, Wi-Fi, and Bluetooth applications. Referring now to FIG. 5, line 122 illustrates operation of an antenna that is not electrically coupled to an electrode, while line 120 illustrates operation of an antenna that is electrically coupled (e.g., RF-coupled) to the electrode. As shown, electrical coupling between the electrodes 104 and the antenna 108 improved the radiation efficiency of the antenna 108 at one or more LTE frequency bands ranging from about 600 MHz to about 960 MHz. The radiation efficiency of the antenna 108 can be improved at the disclosed frequency bands by at least about 2 decibels, such as at least about 3 decibels, such as at least about 4 decibels, such as at least about 5 decibels. Notably, improvements in radiation efficiency of the antenna 108 can be realized without requiring mechanical coupling between the electrodes 104 and the antenna 108. Additional tuning circuits (not shown), including inductors and capacitors, can also be electrically coupled to the electrodes 104 in order to optimize electrode resonance at the operational frequencies of the antenna 108.

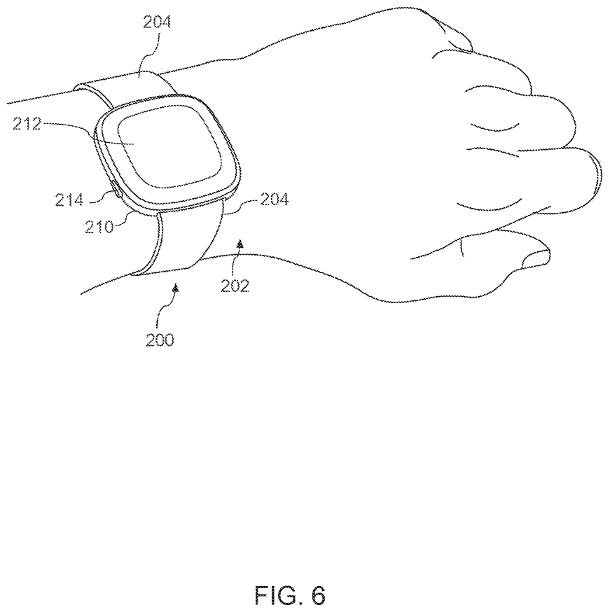

Now referring to FIG. 6, components of the sensor assembly as disclosed can be incorporated into a wearable computing device 200. While the figures illustrate an example embodiment pertaining to a smartwatch, the disclosure is not so limited, and the sensor assembly can be incorporated into any number of wearable computing devices. FIG. 6 depicts a wearable computing device 200 according to some implementations of the present disclosure. As shown, the wearable computing device 200 can be worn, for instance, on a wrist 202 of a user. For instance, the wearable computing device 200 can include a band 204 and a housing assembly 210. The housing assembly 210 can be coupled to the band 204. In this manner, the band 204 can be fastened to the wrist 202 of the user to secure the housing assembly 210 to the wrist 202 of the user.

In some implementations, the wearable computing device 200 can include a display 212 that can display content (e.g., time, date, etc.) to the user. In some implementations, the display 212 can include an interactive display (e.g., touchscreen or touch-free). In such implementations, the user can interact with the wearable computing device 200 via the display 212 to control operation of the wearable computing device 200. Alternatively, or additionally, the wearable computing device 200 can include one or more input devices 214 that can be manipulated by the user to interact with the wearable computing device 200. For instance, the one or more input devices 214 can include a mechanical button that can be manipulated (e.g., pressed) to interact with the wearable computing device 200. In some implementations, the one or more input devices 214 can be manipulated to control operation of a backlight (not shown) associated with the display 212. It should be understood that the one or more input devices 214 can be configured to allow the user to interact with the wearable computing device 200 in any suitable manner. For instance, in some implementations, the one or more input devices 214 can be manipulated by the user to navigate through one or more menus on the display 212.

In some implementations, the wearable computing device 200 can be designed to be worn (e.g., continuously) by the user. When worn, the wearable computing device 200 can gather data regarding activities performed by the user, or regarding the user's physiological state. Such data may include data representative of the ambient environment around the user or the user's interaction with the environment. For example, the data can include motion data regarding the user's movements, ambient light, ambient noise, air quality, etc., and/or physiological data obtained by measuring various physiological characteristics of the user, such as heart rate, perspiration levels, body temperature, and the like.

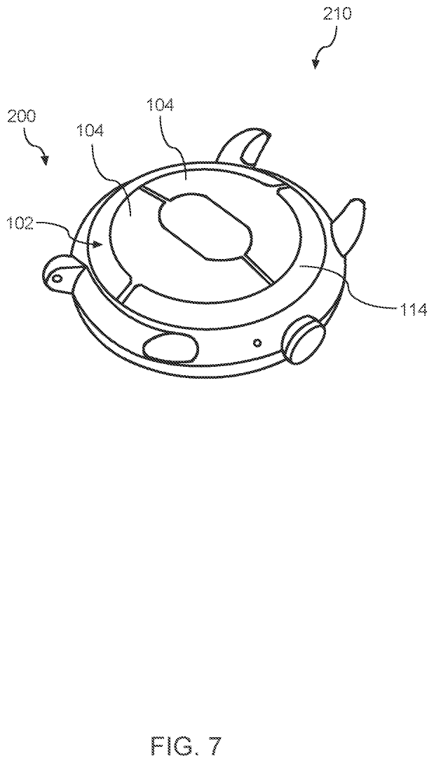

As depicted in FIGS. 7-9, elements of the sensor assembly are incorporated into the wearable computing device 200. For instance, the cover 102 having the electrodes 104 on its outer surface 114 can form a backside or skin-facing side for the wearable computing device 200. The wearable computing device 200 includes a housing assembly 210 in which the printed circuit board 110 having biometric sensor circuitry 112 thereon and the antenna 108 are disposed. Additionally, a wireless charging pairing device 115 can also be disposed within the housing assembly 210 of the wearable computing device 200. The wireless charging pairing device 115 can be configured to operate at an operational frequency to charge the device as will be further discussed hereinbelow.

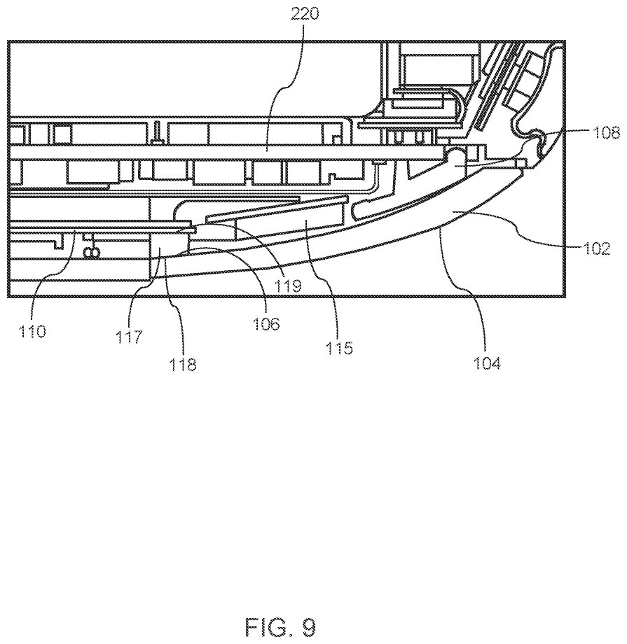

Referring to FIG. 9, a cross-section view of the wearable computing device 200 is shown. The electrical traces can be coupled to the printed circuit board via conductive foam pads, one or more spring clips, one or more pogo-pins, or combinations thereof. As shown, the electrical traces 106 are coupled to the printed circuit board 110 via conductive foam pads 117. The conductive foam pads 117 can be formed from a conductive foam material. For instance, the conductive foam material can be a foam formed from a suitable polymer that is plated with electrically conductive materials (e.g., metal) or from a polymer having electrically conductive material disposed therein. In certain embodiments, the conductive foam material includes a foam that is not electrically conductive that is wrapped in one or more layers of an electrically conductive fabric. Such electrically conductive fabrics are known and can be woven or non-woven fabrics having electrically conductive materials (e.g., metal) dispersed throughout the fabric. The conductive foam pad 117 has a first end 118 coupled to (e.g., in contact with) the electrical trace 106 and a second end 119 coupled to (e.g., in contact with) the printed circuit board 110. Thus, the conductive foam pad 117 serves to electrically couple the electrodes 104 to the printed circuit board 110 such that signals from the electrodes 104 can be processed by the biometric sensor circuitry disposed on the printed circuit board 110. The conductive foam pads 117 can further serve to reduce force within the internal components of the wearable computing device 200. For example, material for the conductive foam pads 117 can be selected such that the conductive foam pads 117 can be compressed between the printed circuit board 110 and the electrical traces 106 on the outer cover 102 without substantially increasing internal forces within the wearable computing device 200.

Furthermore, a main printed circuit board 220 is also provided in the wearable computing device 200. The main printed circuit board 220 can include other circuitry to facilitate functionality of the overall device. Such additional circuitry is known and can include controllers, microcontrollers, processors, microprocessors, modems, modules, or chipsets required to provide for the desired functionality of the wearable computing device 200. Furthermore, components of the sensor assembly can be coupled, either electrically or mechanically, to the main printed circuit board 220 as desired. For instance, in some embodiments, the printed circuit board 110 can be electrically coupled to the main printed circuit board 220. Further, the wireless charging pairing device 115 can also be coupled to the main printed circuit board 220 in order to facilitate charging the wearable computing device 200. Further, the antenna 108 can be electrically coupled to the main printed circuit board 220 as will be further discussed herein below.

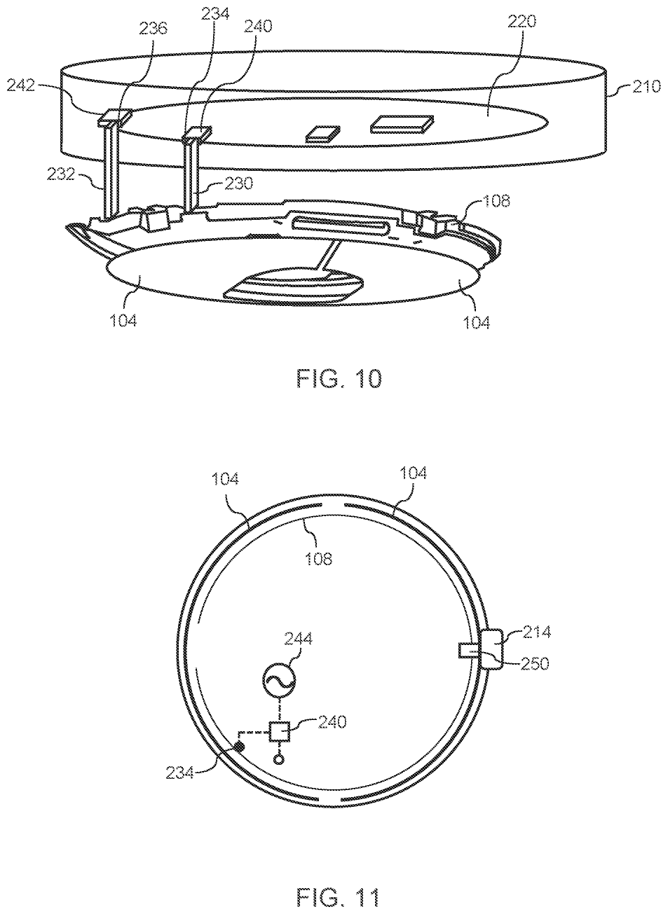

As shown in FIG. 10, the antenna 108 is electrically coupled to the main printed circuit board 220. For instance, known structures for electrically coupling an antenna to a main printed circuit board are known. In some implementations, the main printed circuit board 220 can include a first fastener 230 (e.g., a spring clip) at a first location 234 thereon and a second fastener 232 (e.g., a spring clip) at a second location 236 thereon. In this manner, the antenna 108 can be mechanically coupled to the main printed circuit board 220 at the first location 234 and the second location 236 via the first fastener and the second fastener, respectively. The antenna 108 can be electrically coupled or mechanically coupled to one or more antenna tuning circuits disposed on the main printed circuit board 220. For instance, the antenna 108 can be electrically coupled to a first antenna tuning circuit 240 at the first location 234 and a second antenna tuning circuit 242 at the second location 236. The antenna tuning circuits 240,242 can be used to electrically ground the antenna 108 or to electrically couple the antenna 108 to other components on the main printed circuit board 220, such as a cellular modem, radio chipset, RF circuitry, etc.

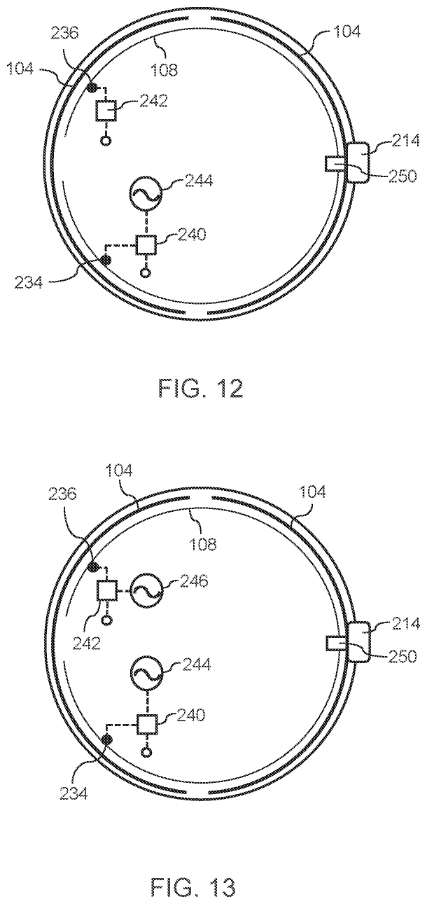

FIGS. 11-13 depict top down schematic views of the electrodes 104 and electrical connections of the antenna 108 to the main printed circuit board 220. As shown, the antenna 108 can be electrically coupled to the main printed circuit board 220 in multiple locations and with multiple configurations. As shown in FIG. 11, the antenna 108 is electrically coupled at a first location 234 to a first antenna tuning circuit 240 that is electrically coupled to a radiator 244, such as an RF generator or a cellular modem. Additionally, the first location 234 and first antenna tuning circuit 240 can be used to electrically ground the antenna 108. In another embodiment, as illustrated in FIG. 12, the antenna 108 is electrically coupled at a first location 234 to a first antenna tuning circuit 240 that is electrically coupled to a radiator 244, such as a cellular modem, and is electrically coupled at a second location 236 to a second antenna tuning circuit 242 that is electrically grounded. In other embodiments, as illustrated in FIG. 13, the antenna 108 is electrically coupled at a first location 234 to a first antenna tuning circuit 240 that is electrically coupled to a radiator 244 and is electrically coupled at a second location 236 to a second antenna tuning circuit 242 that is electrically coupled to an RF circuit 246. The antenna 108 can be configured to be electrically coupled to the main printed circuit board 220 at a variety of different locations as desired and as space allows.

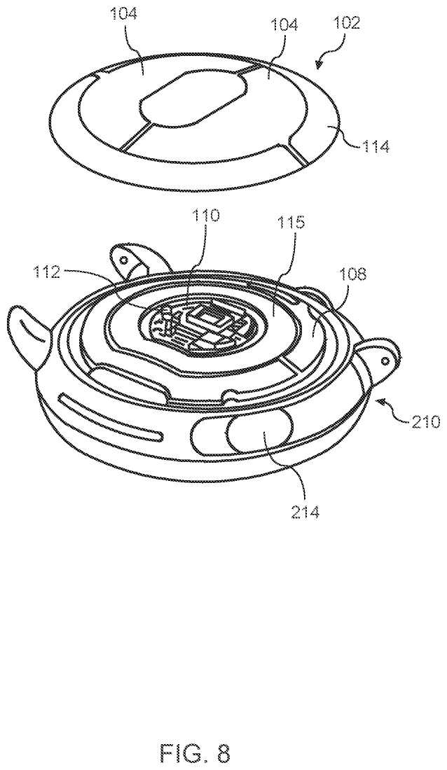

As noted with respect to FIGS. 8-9, a wireless charging pairing device 115 is provided that is configured to charge the wearable computing device 200. The wireless charging pairing device 115 can be configured to charge the device at an operational frequency or over a range of operational frequencies. Such frequencies are generally known in the art. The wireless charging pairing device is electrically coupled to a transmitter that is pulling power from a power source, such as a wall outlet. The wireless charging pairing device 115 then emits radiation at an operational frequency to transfer power from the power source to a portable power source (e.g., a battery) in the wearable computing device 200. However, given the proximity of the disposition of the wireless charging pairing device 115 to the antenna 108 in the wearable computing device 200, the antenna 108 can be electrically coupled to a capacitor 250 in order to filter or block signals at the antenna 108 at the operational frequency(ies) of the wireless charging pairing device 115. FIGS. 11-13 illustrate use and placement of the capacitor 250 on the antenna 108.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure covers such alterations, variations, and equivalents.

What is claimed is:

1. A sensor assembly comprising:
a printed circuit board;
one or more biometric sensor circuits coupled to the printed circuit board;
a cover having one or more electrodes disposed on an outer side of the cover coupled to one or more electrical traces disposed on an inner side of the cover, the one or more electrical traces electrically coupled to the one or more biometric sensor circuits; and
an antenna electrically coupled to the one or more electrodes.

2. The sensor assembly of claim 1, wherein the antenna is radio-frequency coupled to the one or more electrodes.

3. The sensor assembly of claim 1, wherein the one or more electrical traces are electrically coupled to the printed circuit board by one or more conductive foam pads, one or more spring clips, one or more pogo-pins, or combinations thereof.

4. The sensor assembly of claim 3, wherein the one or more conductive foam pads comprise a foam material having one or more layers of conductive fabric thereon.

5. The sensor assembly of claim 1, wherein the one or more electrodes comprise stainless steel, aluminum, or a chromium and silver composite material.

6. The sensor assembly of claim 1, wherein the antenna comprises copper.

7. The sensor assembly of claim 1, wherein the one or more biometric sensor circuits comprise an electrocardiogram (ECG) circuitry.

8. The sensor assembly of claim 1, wherein the one or more biometric sensor circuits comprise a photoplethysmography (PPG) circuitry.

9. The sensor assembly of claim 1, wherein the printed circuit board is a flexible circuit board.

10. A wearable computing device comprising:
a main circuit board;
a flexible printed circuit board electrically coupled to the main circuit board;
one or more biometric sensor circuits coupled to the flexible printed circuit board;
a cover having one or more electrodes disposed on an outer side of the cover coupled to one or more electrical traces disposed on an inner side of the cover, the one or more electrical traces electrically coupled to the one or more biometric sensor circuits; and
an antenna electrically coupled to the one or more electrodes and the main circuit board.

11. The wearable computing device of claim 10, wherein the antenna is radio-frequency coupled to the one or more electrodes.

12. The wearable computing device of claim 10, wherein the one or more electrical traces are electrically coupled to the one or more biometric sensor circuits by one or more conductive foam pads, one or more spring clips, one or more pogo-pins, or combinations thereof.

13. The wearable computing device of claim 12, wherein the one or more conductive foam pads comprise a foam material having one or more layers of conductive fabric thereon.

14. The wearable computing device of claim 10, wherein the one or more electrodes comprise stainless steel, aluminum, or a chromium and silver composite material.

15. The wearable computing device of claim 10, wherein the antenna comprises copper.

16. The wearable computing device of claim 10, wherein the one or more biometric sensor circuits comprise an ECG circuitry.

17. The wearable computing device of claim 10, wherein the one or more biometric sensor circuits comprise a PPG circuitry.

18. The wearable computing device of claim 10, comprising a first antenna spring clip electrically coupled to the antenna and a first antenna tuning circuit disposed on the main circuit board, wherein the first antenna tuning circuit is electrically coupled to a cellular modem disposed on the main circuit board.

19. The wearable computing device of claim 10, comprising a second antenna spring clip electrically coupled to the antenna and a second antenna tuning circuit disposed on the main circuit board, wherein the second antenna spring clip is (i) electrically coupled to an RF circuit disposed on the main circuit board or (ii) is electrically coupled to ground.

20. The wearable computing device of claim 10, comprising a wireless charging pairing device configured to operate at an operational frequency to wirelessly charge the device, further comprising a capacitor electronically coupled to the antenna, the antenna configured to filter signals at the operational frequency of the wireless charging pairing device.
